(19) United States
(12) Patent Application Publication
(10) Pub. No.: US 2006/0153611 A1
(43) Pub. Date: Jul. 13, 2006

(54) Image forming apparatus, finisher used therewith and method for controlling exit tray thereof

(75) Inventor: Toshihiko Murakami, Kanagawa-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/331,645

(22) Filed: Jan. 13, 2006

(30) Foreign Application Priority Data
Jan. 13, 2005 (JP) JP2005-006532

(51) Int. Cl. G03G 15/00

(52) U.S. Cl. 399/405

(57) ABSTRACT

In one embodiment of a method for controlling an exit tray according to the invention, a controller controls an extension tray drive motor and controls the effective length of an extension tray of an image forming apparatus or a finisher employed with the image forming apparatus, based on a signal from a sensor for detecting the position of an extension tray, a signal from a sensor for detecting the presence or absence of a long size recording sheet of paper on an exit tray, and information on the size of a recording sheet of paper on which an image is printed.

### RELATED APPLICATION INFORMATION

This application is based upon and claims the benefits of priority from the prior Japanese Patent Application No. 2005-6532, filed on Jan. 13, 2005; the entire contents of which are incorporated herein by reference.

### BACKGROUND OF THE INVENTION

1. Field of the Invention

The present invention relates to an image forming apparatus, a finisher used with the image forming apparatus, and a method for controlling an exit tray of the image forming apparatus or the finisher.

2. Description of the Related Art

An image forming apparatus such as Multi-Function Peripheral (hereinafter, referred also to “MFP”) combining two or more functions of printing as well as copying, faxing, etc., is often provided in option with a finisher having the capability of sorting or stapling, in order to improve the overall efficiency of a job related to printing.

The finisher is typically provided with two or more exit trays for receiving recording sheets to be output. For example, a user can selectively use a first or second exit tray depending on whether the sheet of paper of a copy job or print job is to be output.

The finisher usually needs to output recording sheets having various sizes and each exit tray needs to receive and stack the output image-formed sheets while preventing the sheets from falling off the tray. However, even if the maximum size of a recording sheet of paper which can be processed by an image forming apparatus or a finisher is A3 (Ledger size in USA) about 80% of recording sheets actually used has been estimated to be A4 size (Letter size in USA).

If it is allowed to consider only the most frequently used size A4, only an exit tray that is optimally adjusted to A4 dimensions and includes no extension tray may be employed. However, if only the exit tray that is optimally adjusted to A4 dimensions and includes no extension tray is employed and when a long size recording sheet of paper such as A3 size sheet of paper is used, the end of the recording sheet of paper exceeds a long length beyond the end of an exit tray body and therefore there is inconvenience of falling off of the recording sheet of paper from the tray.

To prevent such inconvenience, for example, a retractable extension tray is mounted to the end of an exit tray body and when a long size recording sheet of paper is used, the extension tray is extended. Extending the extension tray increases the effective length of the exit tray and prevents the problem of falling off of sheets from the tray even when a long size recording sheet of paper is used. Further, since the extension tray is capable of being retracted into to the tray body (in a retracted position), a space required for installation of an image forming apparatus with an exit tray or a volume needed to pack the image forming apparatus can be reduced.

When a user copies an object to a long size recording sheet of paper using an apparatus such as MTP, the user is usually near the apparatus and therefore the user is able to easily pull out the extension tray.

However, when an apparatus such as MTP is used as a network printer, a user is often far off from the apparatus and therefore, when the user prints an image on a long size recording sheet of paper, the user has to move to the apparatus such as MFP and pull out the extension tray or confirm that the extension tray is being pulled out. This in fact is a time consuming and troublesome task for a user who is forced to move to the apparatus such as MFP in order to confirm that the extension tray is being pulled out or extend the extension tray.

Further, there are occasions in which we encounter a problematic situation in which a user having copied or printed an image on a long size recording sheet of paper often has left the extension tray being extended after the user picked up a hard copy from the tray.

### DESCRIPTION OF THE DRAWINGS

Further objects, features and advantages of the invention can be more fully understood from the following detailed description taken in conjunction with the accompanying drawings, in which:

FIG. 1 is a block diagram showing details of how to control an extension tray and highlighting a finisher according to one embodiment of the invention;

FIG. 2 shows an outline of how the finisher according to one embodiment of the invention operates when the MFP has received a print job; and

FIG. 3 is a flow chart showing the basic process of how to control the exit tray according to one embodiment of the invention when the MFP has received a print job.

### DETAILED DESCRIPTION OF THE INVENTION

Throughout this description, the embodiments and examples shown should be considered as examples, rather than limitations on the apparatus of the present invention.

Embodiments of the invention will be explained with reference primarily to a finisher employed with an image forming apparatus, taken in conjunction with the accompanying drawings.

In one embodiment of the invention, a finisher can be provided with two or more exit trays for receiving a recording sheet of paper conveyed out of the finisher body. However, this does not deny that the finisher is provided with one exit tray. When a finisher provided with two or more exit trays is used, for example, a user can selectively use a first or second exit tray depending on whether the sheet of paper of a copy job or print job is to be output.

Each of the first and second exit trays is disposed in a position where the tray is able to receive a recording sheet of paper and stack the sheet of paper when the recording paper is output from the finisher. Further, in the embodiment of the invention, each tray comprises, for example, an exit tray body having shape and dimensions so as to allow A4 size (Letter size in USA) recording sheets to be stacked on the body and an extension tray capable of being pulled out from the exit tray body during use of a long size recording sheet of paper, in which a combination of those components improves stack performance.

An extension tray drive unit comprising an extension tray drive motor, a guide member, and an extension tray position detection sensor is provided within the exit tray body, and the extension tray is connected to the extension tray drive unit. The extension tray drive unit is operable to pull out the extension tray from the exit tray body in a direction in which a recording sheet of paper is output and conversely pulled the extension tray back into the exit tray body. It should be noted that the torque of the extension tray drive motor to hold the tray is set at a value to allow a typical user to apply an appropriate force to the extension tray to cause the extension tray to be pulled out from and pulled back into the exit tray body.

Further, a long size recording sheet of paper detection sensor is provided in the vicinity of an end portion of the tray body, which portion opposes a recording sheet of paper output unit of the finisher, and the long size recording sheet of paper detection sensor detects the presence or absence of a long size recording sheet of paper on the exit tray.

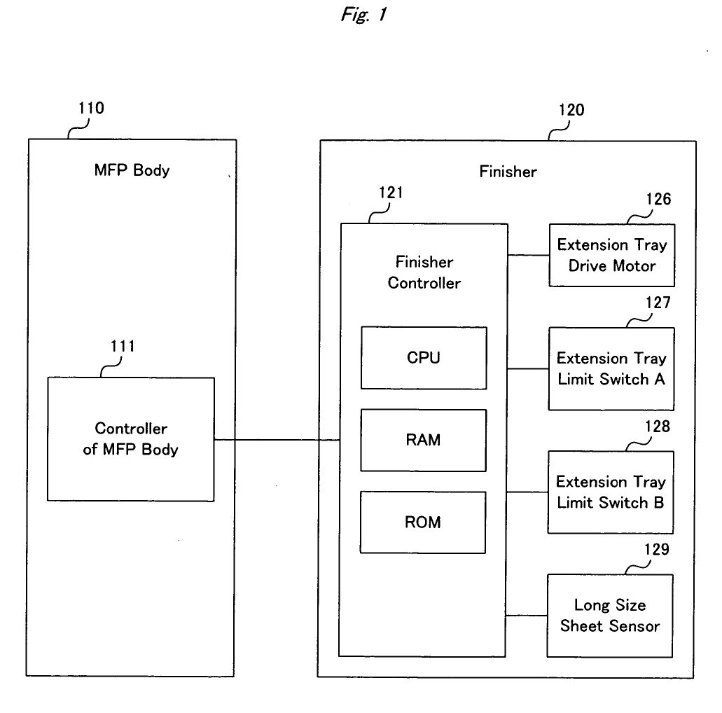

FIG. 1 is a block diagram showing details of how to control an extension tray and highlighting a finisher according to one embodiment of the invention. In FIG. 1, numeral 110 denotes an MFP body and numeral 120 denotes a finisher. When the MFP receives a print job, the MFP acquires document data to be printed out as well as information on the size of a recording sheet of paper to be printed on. A controller 111 of the MFP 110 sends information indicating that a print job has been received as well as the information on the size of a recording sheet of paper to a controller 121 of the finisher 120. Incidentally, the finisher controller 121 comprises a CPU controlling the finisher 120, a ROM storing a program, etc., for controlling the finisher 120, and a RAM occupied by a working area of the program and temporarily storing data needed to control the finisher 120. The finisher controller 121 further comprises an interface (not shown) with a device for controlling an extension tray discussed below.

Further, the finisher 120 comprises a motor 126 driving the extension tray of an exit tray present in the extension tray drive unit provided within the exit tray body, an extension tray limit switch A 127 serving as a sensor for detecting the position of the extension tray, an extension tray limit switch B 128, and a long size sheet sensor 129 detecting that long size recording sheets are stacked on a tray. It should be noted that, for example, the extension tray limit switch A 127 is disposed at a position from which the extension tray starts to be extended (i.e., retracted position) and the extension tray limit switch B 128 is disposed at a position to which the extension tray is fully extended (i.e., extended position). These switches should be considered an example of an approach to controlling the extension tray and it is needless to say, other devices may be used instead of the above switches as long as the device is capable of driving the extension tray of an exit tray, detecting the position of the extension tray, and detecting that long size recording sheets are stacked on a tray.

The finisher further comprises a device for controlling one or more exit trays, however, the operation of that device does not affect directly the control of the extension tray and therefore the illustration of the device is omitted.

Next, the operation of the extension tray will be explained with reference to the drawings.

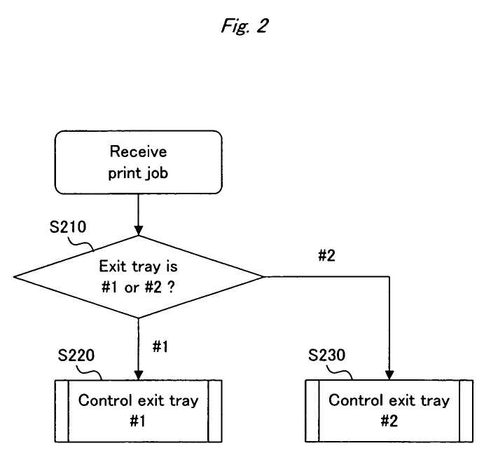

FIG. 2 shows an outline of how the finisher 120 having two exit trays operates when the MFP 110 has received a print job. When the finisher 120 has a plurality of exit trays, information on a print job received by the MFP 110 also includes information specifying to which one of the exit trays the printed recording sheet of paper is to be directed. The MFP 110 sends the information specifying an exit tray to the finisher controller 121 via the MFP controller 111. The finisher controller 121 identifies which one of the exit tray 1 and exit tray 2 is to be used to receive printed sheets based on the received information specifying an exit tray in step S210. When the finisher 121 identifies the exit tray 1 that is to be used to receive printed-sheets, the finisher performs control of the exit tray 1 (S220). Similarly, when the finisher 121 identifies the exit tray 2 that is to be used to receive printed sheets, the finisher performs control of the exit tray 2 (S230)

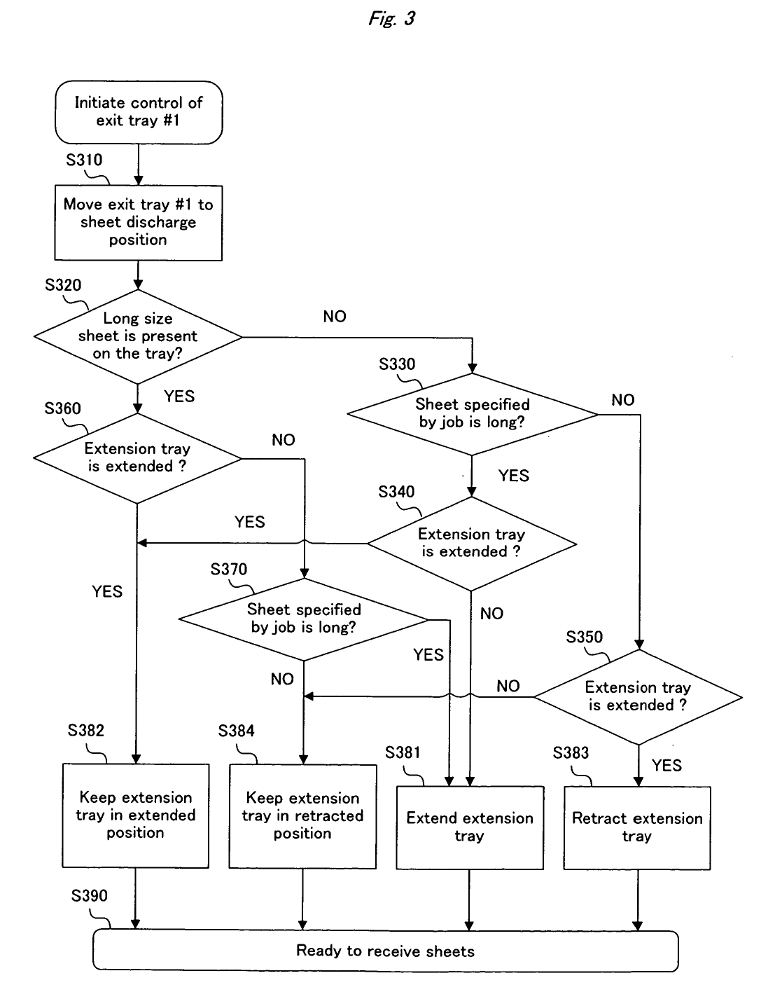

FIG. 3 is a flow chart showing the basic concept of how to control the exit tray 1 (S220) when the MFP 110 has received a print job that specifies the exit tray 1. It should be noted that the basic concept of how to control the exit tray 2 (S230) is fully the same as that of how to control the exit tray 1 and when a print job that specifies the exit tray 1 and a print job that specifies the exit tray 2 are executed concurrently, control of the exit tray 1 and control of the exit tray 2 are independently performed.

After the controller 121 of the finisher 120 has received information indicating that the controller 111 of the MFP 110 received a print job that specifies the exit tray 1, the controller 121 first moves the exit tray 1 to a sheet of paper discharge position in step S310. However, if the number of exit trays is one, control of the exit tray in step S310 is not performed.

Next, in step S320, whether or not, for example, an A3 size recording sheet of paper is present on the exit tray 1 is identified based on a signal from the long size recording sheet detection sensor 129. Resultantly, when it is identified that the long size recording sheet of paper is not present on the exit tray 1, whether or not the recording sheet of paper to be used is a long size sheet of paper is determined based on the information on the size of a recording sheet of paper that is specified by the print job sent from the MFP controller 111 (S330) If the recording sheet of paper to be used is a long size sheet of paper, the position of the extension tray is detected, depending on the states of the extension tray limit switch A (127) disposed in the extension tray drive unit at a position from which the extension tray starts to be extended and the extension tray limit switch B (128) disposed at a position to which the extension tray is fully extended, and then, whether or not the extension tray has been extended is determined (S340). If step S340 determines that the extension tray is not extended, the motor 126, provided in the extension tray drive unit, for driving the extension tray of an exit tray is actuated to extend the extension tray in step S381. When the extension tray is brought into an extended position, the finisher is ready to receive sheets (S390) In this way, the extension tray is automatically brought into an extended position and therefore a user is able to print a desired image on the long size recording sheet of paper without physically moving to the exit tray to extend the extension tray.

If step S240 determines that the extension tray is being in an extended position, the extension tray remains in an extended position (S382).

If step S330 determines that the recording sheet of paper to be used is not a long size sheet of paper, whether or not the extension tray is being in an extended position is determined in step S350. If step S350 determines that the extension tray is being in an extended position, the motor 126, provided in the extension tray drive unit, for driving the extension tray of an exit tray is actuated to retract the extension tray in step S383. In this way, we will never encounter the situation in which the extension tray is being unnecessarily in an extended position. If step S350 determines that the extension tray is not in an extended position, the extension tray remains in a retracted position in step S384.

We have shown in the foregoing how the inventive finisher operates when step S320 determines that a long size recording sheet of paper is not present on the exit tray 1. Next, it will be explained in the following how the inventive finisher operates when step S320 determines that a long size recording sheet of paper is present on the exit tray 1.

In this example, first, step S360 determines whether or not the extension tray is being in an extended position. If step S360 determines that the extension tray is being in an extended position, the extension tray remains in an extended position in step S392.

Contrary to it, if step S360 determines that the extension tray is not in an extended position, step S370 determines whether or not the recording sheet of paper to be used is a long size sheet of paper based on information on the size of a recording sheet of paper that is specified by the print job. If the recording sheet of paper to be used is a long size sheet of paper, the extension tray is brought into an extended position in step S381. If the recording sheet of paper to be used is not a long size sheet of paper, the extension tray remains in a retracted position in step S384. It should be noted that the case where the inventive finisher operates when step S320 determines that a long size recording sheet of paper is present on the exit tray 1 is assumed in this example and therefore it could be expected that the extension tray currently being in an extended position, however, the situation in which a user accidentally puts a long size sheet of paper on the exit tray in a state where the extension tray is being in a retracted position is likely to happen, and in some cases, it is determined that the extension tray is not being in an extended position.

We have shown in the foregoing the basic concept of how to control the exit tray 1 (S220) when the MFP 110 has received a print job that specifies the exit tray 1. However, attention should be directed to the case where a subsequent print job is submitted during the control of the exit tray specified by-the current print job. More specifically, attention should be directed to the case where a subsequent print job specifying a long size recording sheet of paper which is to be used for printing is submitted immediately after the current print job is executed such that the extension tray is brought into a retracted position in step S383 of FIG. 3 or the extension tray remains in a retracted position in step S384 of FIG. 3. When it is allowed not to consider the subsequent print job, the extension tray starts to be brought into a retracted position or remains in a retracted position and accordingly, it could be observed that when the subsequent print job is submitted and a long size recording sheet of paper is going to be driven out to the exit tray, the extension tray is not being fully extended.

Here, we give an example of how to avoid such an event. The finisher controller 121 monitors the information on an exit tray specified by the second job, which information is contained in print job information sent to the finisher controller 121 upon receipt of a print job by the MFP 110, and determines whether or not the print job is a job that specifies a long size recording sheet of paper which is to be used for printing. If the second print job is not a job that specifies a long size recording sheet of paper which is to be used for printing, the control of the extension tray specified by the preceding print job is continued. On the other hand, when the second print job is a job that specifies a long size recording sheet of paper which is to be used for printing and the preceding print job is not is a job that specifies a long size recording sheet of paper which is to be used for printing, the control of the extension tray specified by the preceding print job is stopped and the control of the extension tray specified by the second print job is immediately initiated. In this way, even when different print jobs are submitted simultaneously, “overlapping” them, the invention can be successfully implemented.

So far, we have shown in FIG. 3 the basic concept of how to control the exit tray of the finisher according to one embodiment of the invention when the MFP 110 has received a print job.

Next, how the finisher operates after the print job is completed and a recording sheet of paper specified by the print job is output from the finisher will be explained.

First, after the print job is completed and a recording sheet of paper specified by the print job is output from the finisher, and when the extension tray is being in a retracted position, the MFP keeps its current state and waits for another print job. After the print job is completed and a recording sheet of paper specified by the print job is output from the finisher, and when the extension tray is being in an extended position and a long size sheet of paper is present on the exit tray, the extension tray remains in an extended position until the long size sheet of paper is removed from the exit tray. When it is detected that the long size sheet of paper has been removed from the exit tray, it is confirmed that another print job specifying a long size recording sheet of paper which is to be used for printing is not received and then the extension tray is brought into a retracted position.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

For example, various modifications can be made to the methods described using FIG. 3, in order to control an exit tray. That is, the order in which the size of a sheet of paper specified by a job is determined, presence or absence of a long size sheet of paper on the exit tray is determined, and whether or not the extension tray is being in an extended position is determined is not limited to the order shown in FIG. 3 and various modifications can be made to the order in which the determinations are made, in order to control an exit tray.

Further, although the exit tray has been explained as having the tray body and the extension tray which can be extended from or retracted into the tray body, it is needless to say that the exit tray may be configured so that the extension tray is folded into and unfolded from the tray body or one piece exit tray is extended and retracted. It should be noted that the exit tray is simply configured so that the exit tray is extended or retracted to increase or reduce its effective length. That is, for example, the exit tray according to the invention can be configured so that while the actual length of the exit tray is kept unchanged, a portion of the exit tray is extended from and retracted into the body of the apparatus that delivers a recording sheet of paper to be received by the exit tray and the length of that portion receiving the delivered sheet of paper is variable. Further, although the explanation has been made as to the case where a recording sheet of paper on which an object has been printed is received by the exit tray, the invention is applicable to the case where a recording sheet of paper on which an image has been copied is received by the exit tray.

Additionally, although the explanation of the exit tray provided in the finisher according to one embodiment of the invention has been given, it is apparent that the invention is applicable not only to the exit tray of a finisher, but also the exit tray of the body of an image forming apparatus such as a printer, copy machine, MFP, etc.

Accordingly, the invention is applicable to an image forming apparatus, such as a printer, copy machine, MFP, etc., or to a finisher incorporated in an image forming apparatus.

Further, the invention is not limited to a recording sheet of paper and may be applied to a sheet made of a material other than paper.

Additionally, the invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications.

According to the invention, an image forming apparatus offering convenience to a user who wants to handle a long size recording sheet of paper or a finisher incorporated in an image forming apparatus is provided or a method for controlling an exit tray is provided.

What is claimed is:

1. An image forming apparatus comprising:
an exit tray extended or retracted, in a direction in which a recording sheet of paper is conveyed out, to increase or decrease the effective length of the tray and stacking thereon the recording sheet of paper to be conveyed out;
a drive unit for causing the exit tray to be extended or retracted to increase or decrease the effective length of the tray;
an extended/retracted position determination unit for determining whether the exit tray is in an extended or retracted position;
a long size recording sheet of paper presence/absence determination unit for determining the presence or absence of a long size recording sheet of paper on the exit tray; and
a controller for receiving in advance information on the length of a recording sheet of paper to be conveyed out and receiving signals from the extended/retracted position determination unit and the long size recording sheet of paper presence/absence determination unit, and controlling the drive unit.

2. A finisher incorporated in an image forming apparatus, comprising:
an exit tray extended or retracted, in a direction in which a recording sheet of paper is conveyed out, to increase or decrease the effective length of the tray and stacking thereon the recording sheet of paper to be conveyed out;
a drive unit for causing the exit tray to be extended or retracted to increase or decrease the effective length of the tray;
an extended/retracted position determination unit for determining whether the exit tray is in an extended or retracted position;
a long size recording sheet of paper presence/absence determination unit for determining the presence or absence of a long size recording sheet of paper on the exit tray; and
a controller for receiving in advance information on the length of a recording sheet of paper to be conveyed out and receiving signals from the extended/retracted position determination unit and the long size recording sheet of paper presence/absence determination unit, and controlling the drive unit.

3. A method for controlling an exit tray, comprising:
determining whether or not a long size recording sheet of paper is present on an exit tray;
determining whether the exit tray is in an extended or retracted position;
receiving in advance information on the length of a recording sheet of paper to be conveyed out to the exit tray; and
based on information obtained by determining whether or not a long size recording sheet of paper is present on the exit tray, information obtained by determining whether the exit tray is in an extended or retracted position, and information received in advance on the length of a recording sheet of paper to be conveyed out to the exit tray, controlling the exit tray so that the exit tray is extended or retracted to increase or reduce the effective length of the exit tray.

4. The method for controlling an exit tray according to claim 3, wherein if the exit tray is determined to be in a retracted position in determining whether the exit tray is in an extended or retracted position and information indicating a long size recording sheet of paper is going to be conveyed out is received in receiving in advance information on the length of a recording sheet of paper to be conveyed out to the exit tray, controlling the exit tray so that the exit tray is extended to increase the effective length of the exit tray.

5. The method for controlling an exit tray according to claim 3, wherein if a long size recording sheet of paper is determined to not be present on the exit tray in determining whether or not a long size recording sheet of paper is present on an exit tray, the exit tray is determined to be in an extended position in determining whether the exit tray is in an extended or retracted position, and information indicating a long size recording sheet of paper is not going to be conveyed out is received in receiving in advance information on the length of a recording sheet of paper to be conveyed out to the exit tray, controlling the exit tray so that the exit tray is retracted to reduce the effective length of the exit tray.

6. The method for controlling an exit tray according to claim 3, wherein if the fact that the exit tray is determined to be in an extended position in determining whether the exit tray is in an extended or retracted position, a long size recording sheet of paper is determined to not be present on the exit tray in determining whether or not a long size recording sheet of paper is present on an exit tray, information indicating a long size recording sheet of paper is going to be conveyed out is received in receiving in advance information on the length of a recording sheet of paper to be conveyed out to the exit tray, or if the exit tray is determined to be in an extended position in determining whether the exit tray is in an extended or retracted position, controlling the exit tray so that the exit tray having an increased effective length remains in an extended position.

7. The method for controlling an exit tray according to claim 3, wherein if the exit tray is determined to be in a retracted position in determining whether the exit tray is in an extended or retracted position, information indicating a long size recording sheet of paper is not going to be conveyed out is received in receiving in advance information on the length of a recording sheet of paper to be conveyed out to the exit tray, and a long size recording sheet of paper is determined to not be present on the exit tray in determining whether or not a long size recording sheet of paper is present on an exit tray, controlling the exit tray so that the exit tray having a reduced effective length remains in a retracted position.

8. A computer program product comprising a computer usable medium having computer readable program code embodied therein for causing a processor to:
determine whether or not a long size recording sheet of paper is present on an exit tray;
determine whether the exit tray is in an extended or retracted position;
receive in advance information on the length of a recording sheet of paper to be conveyed out to the exit tray; and
control the exit tray so that the exit tray is extended or retracted to increase or reduce the effective length of the exit tray, based on information obtained by determining whether or not a long size recording sheet of paper is present on the exit tray, information obtained by determining whether the exit tray is in an extended or retracted position, and information received in advance on the length of a recording sheet of paper to be conveyed out to the exit tray.

9. The computer program product according claim 8 having computer readable program code embodied therein for causing a processor to:
control the exit tray so that the exit tray is extended to increase the effective length of the exit tray if the exit tray is determined to be in a retracted position when determination is made as to whether the exit tray is in an extended or retracted position and information indicating a long size recording sheet of paper is going to be conveyed out is received when information on the length of a recording sheet of paper to be conveyed out to the exit tray is received in advance.

10. The computer program product according claim 8 having computer readable program code embodied therein for causing a processor to:
control the exit tray so that the exit tray is retracted to reduce the effective length of the exit tray if a long size recording sheet of paper is determined to not be present on the exit tray when determination is made as to whether or not a long size recording sheet of paper is present on the exit tray, the exit tray is determined to be in an extended position when determination is made as to whether the exit tray is in an extended or retracted position, and information indicating a long size recording sheet of paper is not going to be conveyed out is received when information on the length of a recording sheet of paper to be conveyed out to the exit tray is received in advance.

11. The computer program product according claim 8 having computer readable program code embodied therein for causing a processor to:
control the exit tray so that the exit tray having an increased effective length remains in an extended position if the exit tray is determined to be in an extended position when determination is made as to whether the exit tray is in an extended or retracted position, a long size recording sheet of paper is determined to not be present on the exit tray when determination is made as to whether or not a long size recording sheet of paper is present on the exit tray, and information indicating a long size recording sheet of paper is going to be conveyed out is received when information on the length of a recording sheet of paper to be conveyed out to the exit tray is received in advance, or if the exit tray is determined to be in an extended position when determination is made as to whether the exit tray is in an extended or retracted position.

12. The computer program product according claim 8 having computer readable program code embodied therein for causing a processor to:
control the exit tray so that the exit tray having a reduced effective length remains in a retracted position if the exit tray is determined to be in a retracted position when determination is made as to whether the exit tray is in an extended or retracted position, information indicating a long size recording sheet of paper is not going to be conveyed out is received when information on the length of a recording sheet of paper to be conveyed out to the exit tray is received in advance, and a long size recording sheet of paper is determined to not be present on the exit tray when determination is made as to whether or not a long size recording sheet of paper is present on the exit tray.
